(19) United States
(12) Patent Application Publication
(10) Pub. No.: US 2023/0126035 A1
(43) Pub. Date: Apr. 27, 2023

(54) CUTTING MEMBER FOR SHAVING RAZORS WITH MULTIPLE BLADES THAT FEATURE NARROW PLATFORM TO FACILITATE RINSING/ WELDED BLADE ON SUPPORT WITH NARROW PLATFORM PORTION

(71) Applicant: BIC Violex Single Member S.A., Anoixi (GR)

(72) Inventors: Charalampos SCHIZAS, Anoixi (GR); Christos AMPATIS, Anoixi (GR); Christos GALANIS, Anoixi (GR); Thanasis KARAGIANNIS, Anoixi (GR)

(73) Assignee: BIC Violex Single Member S.A., Anoixi (GR)

(21) Appl. No.: 17/760,433

(22) PCT Filed: Feb. 25, 2021
(86) PCT No.: PCT/EP2021/054658

§ 371 Date: Aug. 9, 2022

(30) Foreign Application Priority Data
Mar. 18, 2020 (EP) 20163838.4

(51) Int. Cl. B26B 21/16

(52) U.S. Cl. CPC B26B 21/165

(57) ABSTRACT

A shaving head comprising a guard, a first blade, and a second blade, the first blade comprising a first cutting element and a support, the first cutting element comprising a cutting edge portion and a mounting portion, the cutting edge portion presenting a cutting edge, the mounting portion extending from the cutting edge portion in an opposite direction from the cutting edge, the mounting portion being mounted on the support, the second blade comprising a second cutting element presenting a cutting edge, the first and second blades directly adjacent to one another such that an inter-blade clearance between the first and second blades ranges from 0.25 mm to 0.55 mm, and such that an inter-blade span between the cutting edges of the first and second cutting elements ranges from 0.90 mm to 1.60 mm.

### CROSS REFERENCE TO RELATED APPLICATION

This application is a National Stage Application of International Application No. PCT/EP2021/054658, filed on 25th February 2021, now published as WO2021185550 and which claims priority from European patent application EP 20163838.4, filed on 18th March 2020, its content being incorporated herein by reference.

### FIELD

The present disclosure relates to the field of shaving, and in particular to a shaving head and a blade therefor.

### BACKGROUND ART

A shaving head is a shaving apparatus including one or more blades (each with at least one cutting edge) and a guard to which the one or more blade is/are attached. Shaving heads are commonly found in safety razors, such as removable-blade razors (in which the blade is removable from the guard), disposable razors (in which the shaving head and an associated manipulation portion such as a handle are replaced simultaneously with one another), and cartridge razors (in which the shaving head is dissociable and replaceable separately from the manipulation portion).

When a shaving head includes at least two blades, the blades may be understood to be assembled to one another when they both are attached to the guard.

When a shaving head includes two or more blades which are arranged to contact skin concurrently during shaving with their respective cutting edges, the cutting edge of a first of the two or more blades may be substantially parallel to the cutting edge of a second of the two or more blades.

When multiple cutting edges are arranged to contact skin concurrently during shaving, the cutting edges may be understood to lie in or offset with respect to a shaving surface. During shaving, the cutting edges are moved along skin following a shaving path, which lies in the shaving surface, perpendicular to the cutting edges. Hair removal occurs when movement along the shaving path occurs according to a shaving direction. The shaving surface is defined as a plane tangential to leading and trailing skin contact points (with respect to the shaving direction) of the shaving head. The shaving head’s blade exposure is a distance by which the cutting edge(s) are offset from the shaving surface, as measured normal to the shaving surface.

Users frequently rate their satisfaction with a given shaving head based on factors such as comfort and ease of use during shaving. During shaving, debris such as hair and/or skin cells and/or sebum, possibly in combination with one or more shaving products such as shaving cream or shaving oil, may accumulate in the shaving head. One factor which may be influential in users’ perceptions of a shaving head’s ease of use may be the relative ease with which such debris is dislodged from the shaving head.

### SUMMARY

It is therefore desirable to provide a shaving head which is easy to rinse. According to examples of the present disclosure, a shaving head may be provided. The shaving head includes a guard, a first blade and a second blade. The first blade includes a first cutting element and a support. The first cutting element includes a cutting edge portion and a mounting portion. The cutting edge portion includes a cutting edge. The mounting portion extends from the cutting edge portion in an opposite direction from the cutting edge. The mounting portion is mounted on the support. The second blade includes a second cutting element. The second cutting element includes a cutting edge. The first and second blades are arranged directly adjacent to one another. The cutting edges of the first and second cutting elements are substantially parallel to each other and arranged to contact skin concurrently during shaving. An inter-blade clearance between the first and second blades ranges from 0.25 (millimeters) mm to 0.55 mm. Inter-blade clearance is a minimum distance between directly adjacent blades. An inter-blade span between the first and second cutting elements ranges from 0.9 mm to 1.60 mm. Inter-blade span is a minimum distance between two directly adjacent cutting edges.

Such a shaving head may exhibit high rinsabilty while nevertheless being perceived as comfortable by users during shaving.

An overhang length of the first blade may range from 0.5 mm to 1 mm, or from 0.55 mm to 1 mm, or from 0.55 mm to 0.88 mm.

The support may include a platform portion on which the mounting portion is mounted. The platform portion may extend along the mounting portion. The support may include a base portion extending obliquely or perpendicularly from the platform portion for assembly of the first blade to the guard.

The base portion may have a thickness of 0.1 mm to 0.3 mm, as measured normal to an inner surface of the base portion.

The platform portion may have a length of 0.5 mm to 0.9 mm. The platform portion’s length may be measured along the mounting portion, from an interior vertex formed by surfaces of the platform and base portions which face one another, towards the cutting edge of the cutting edge portion.

A ratio of a length of the platform portion to a length of the first blade may range from 0.33 to 0.64.

The length of the first blade may be measured along the mounting portion, from the interior vertex to the cutting edge.

An outer surface of the base portion may be arranged away from the platform portion. A width of the first blade may range from 0.9 mm to 1.70 mm. The first blade’s width may be measured from the outer surface of the base portion to the cutting edge of the cutting edge portion in a direction normal to the outer surface of the base portion.

An overlap length between the first and second blades may range from 0 mm to 0.55 mm.

The support may be intermediate the first cutting element and the second blade. Alternatively, the first cutting element may be intermediate the support and the second blade.

The first cutting element may be arranged on a surface of the support which is arranged towards skin during shaving.

The first cutting element may be arranged on a surface of the support which is arranged away from skin during shaving.

A razor may be provided, including a shaving head as described earlier herein.

The razor may include a vibrator.

A method of fabricating a shaving head as described earlier herein is also provided. The method includes providing the first blade and providing the second blade, and assembling the first and second blades together.

Providing the first blade may include providing the support and providing the first cutting element. Providing the support may include providing a flat element and bending the flat element to obtain the support. The support may include a base portion, for assembly of the first blade to the second blade, and a platform portion to which the first cutting element may be mountable. The platform portion may extend obliquely or perpendicularly from the base portion. Providing the first blade may lack a step of removing material from the platform portion of the support subsequent to the bending step.

Assembling the first and second blades together may include retaining the second blade to a guard, and retaining the base portion of the first blade to the guard.

The method may include a step of measuring rinsability of the shaving head.

A process of measuring rinsability of a shaving head, for such a method, is also provided. The process includes mounting the shaving head downstream of a liquid dispenser and upstream of a first flow path and a second flow path that is separate from the first flow path, such that liquid dispensed from the liquid dispenser is delivered to the shaving head, and such that liquid traversing the shaving head is directed along the first flow path, and such that liquid bypassing the shaving head is directed along the second flow path. The process includes dispensing a known quantity of liquid from the liquid dispenser. The process includes measuring a quantity of liquid directed along the first flow path and/or a quantity of liquid directed along the second flow path.

The process may include arranging a gasket between the shaving head and a boundary of the first flow path.

### BRIEF DESCRIPTION OF THE DRAWINGS

The disclosure may be more completely understood in consideration of the following detailed description of aspects of the disclosure in connection with the accompanying drawings, in which:

FIG. 1A shows a blade arrangement for a reference shaving head;

FIG. 1B shows a schematic representation of a relationship between shaving head geometry and user experience;

FIG. 2A shows an exemplary blade arrangement for an exemplary shaving head;

FIG. 2B shows the first blade seen in FIG. 2A;

FIG. 3 shows a comparison between a reference blade seen in FIG. 1A and the exemplary blade seen in FIG. 2B;

FIG. 4 shows debris stacking for the reference blade seen in FIG. 3;

FIG. 5 shows debris stacking for the exemplary blade seen in FIG. 3;

FIG. 6 shows a process flow diagram for fabricating an exemplary shaving head;

FIG. 7A shows a process flow diagram for an exemplary process for measuring rinsability of a shaving head;

FIG. 7B shows a schematic view of an apparatus for measuring rinsability of a shaving head;

FIG. 8 shows a detail view of the apparatus represented in FIG. 7B;

FIG. 9 shows the blade arrangement of FIG. 1A during rinsing;

FIG. 10 shows the blade arrangement of FIG. 2A during rinsing;

FIG. 11 shows an exemplary razor including an exemplary shaving head.

The term “exemplary” is used in the sense of “example,” rather than “ideal.” While aspects of the disclosure are amenable to various modifications and alternative forms, specifics thereof have been shown by way of example in the drawings and will be described in detail. It should be understood, however, that the intention is not to limit aspects of the disclosure to the particular embodiment(s) described. On the contrary, the intention of this disclosure is to cover all modifications, equivalents, and alternatives falling within the scope of the disclosure.

### DETAILED DESCRIPTION

As used in this disclosure and the appended claims, the singular forms “a”, “an”, and “the” include plural referents unless the content clearly dictates otherwise. As used in this disclosure and the appended claims, the term “or” is generally employed in its sense including “and/or” unless the content clearly dictates otherwise.

The following detailed description should be read with reference to the drawings. The detailed description and the drawings, which are not necessarily to scale, depict illustrative aspects and are not intended to limit the scope of the disclosure. The illustrative aspects depicted are intended only as exemplary.

When an element or feature is referred to herein as being “on,” “engaged to,” “connected to,” or “coupled to” another element or feature, it may be directly on, engaged, connected, or coupled to the other element or feature, or intervening elements or features may be present. In contrast, when an element or feature is referred to as being “directly on,” “directly engaged to,” “directly connected to,” or “directly coupled to” another element or feature, there may be no intervening elements or features present. Other words used to describe the relationship between elements or features should be interpreted in a like fashion (for example, “between” versus “directly between,” “adjacent” versus “directly adjacent,” etc.).

Although the terms “first,” “second,” etc. may be used herein to describe various elements, components, regions, layers, sections, and/or parameters, these elements, components, regions, layers, sections, and/or parameters should not be limited by these terms. These terms are only used to distinguish one element, component, region, layer, or section from another region, layer, or section. Thus, a first element, component, region, layer, or section discussed herein could be termed a second element, component, region, layer, or section without departing from the teachings of the present inventive subject matter.

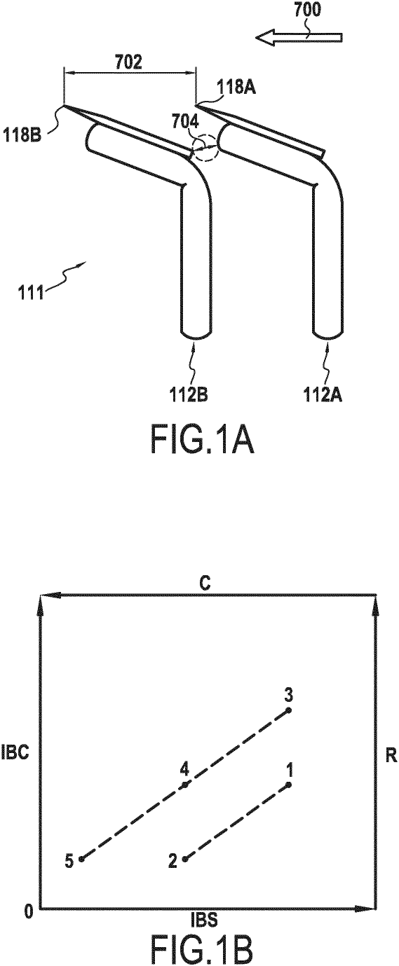

FIG. 1A shows a reference blade arrangement 111 for a reference shaving head.

In the reference blade arrangement 111, the first 112A and second 112B reference blades are arranged such that movement of the reference shaving head in its shaving direction 700 causes the first reference blade 112A to trail the second reference blade 112B.

The reference blade arrangement 111 has an inter-blade span 702 of 1.3 mm (millimeters) between the cutting edges 118A, 118B of the first 112A and second 112B reference blades. Inter-blade span is a distance between directly adjacent cutting edges.

FIG. 1B shows a schematic representation of a relationship between shaving head geometry and user experience. When a user shaves using a shave head in which multiple cutting edges contact the skin concurrently during shaving, contact of the cutting edges on the skin may be perceived by the user as unpleasant or uncomfortable. User feedback has revealed that a shaving head with relatively large inter-blade span (“IBS,” represented along the lower horizontal axis) - of which an example is represented at position 1 - may be perceived as less comfortable (user comfort “C” being represented on the upper horizontal axis) than a shaving head relatively small inter-blade span - of which an example is represented at position 2.

However, debris may accumulate between directly adjacent blades during shaving, possibly to the point of reducing shaving efficacy. Testing and user feedback have revealed that a relatively small inter-blade span (position 2) may reduce the effectiveness of rinsing at dislodging accumulated debris. In other words, it may reduce rinsability of the shaving head (rinsability “R” being represented on the right vertical axis). As an example, a user may perceive that a shaving head with relatively low rinsability requires longer and/or more forceful and/or more copious rinsing than a shaving head with relatively high rinsability.

The inventors have realized that inter-blade clearance (“IBC,” represented on the left vertical axis) may be more influential than inter-blade span in determining rinsability of at least certain shaving heads. Inter-blade clearance is a minimum distance between directly adjacent blades. The shaving heads represented at positions 3 & 4 have larger inter-blade clearances than the shaving heads represented at positions 1 & 2, respectively, and also exhibit higher rinsability than the shaving heads represented at positions 1 & 2, respectively. The shaving head represented at position 5 exhibits comparable rinsability to the shaving head represented at position 2, even though the shaving head represented at position 5 has a smaller inter-blade span than the shaving head represented at position 2.

Returning now to FIG. 1A, the reference blade arrangement 111 has an inter-blade clearance 704 of 0.29 mm between the first 112A and second 112B reference blades.

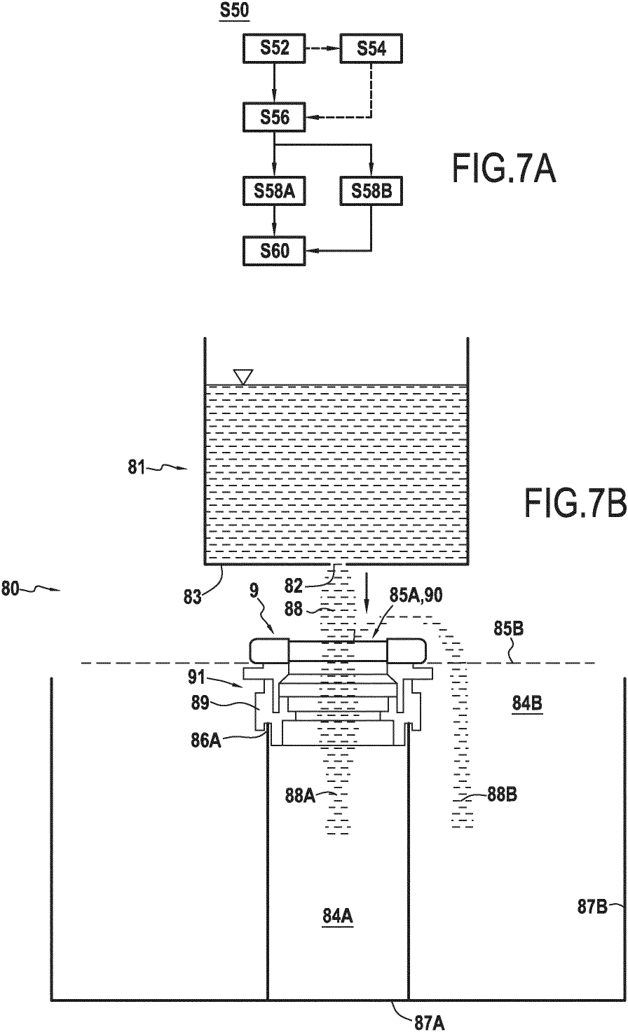

Quantification of rinsability will be discussed in greater detail with regard to FIGS. 7A–10 .

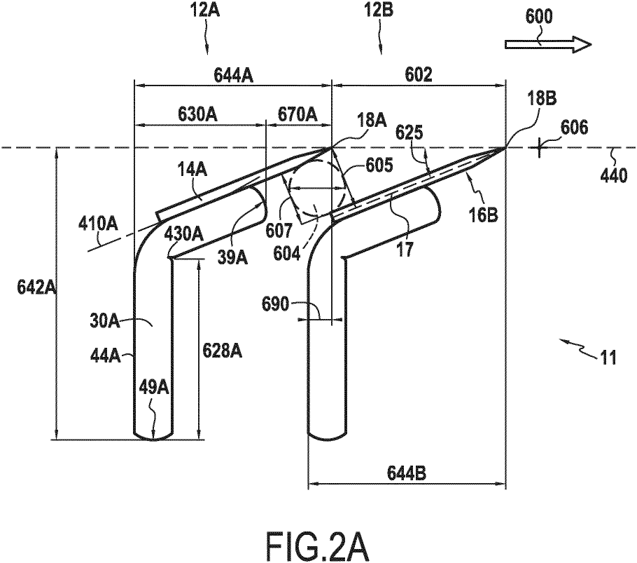

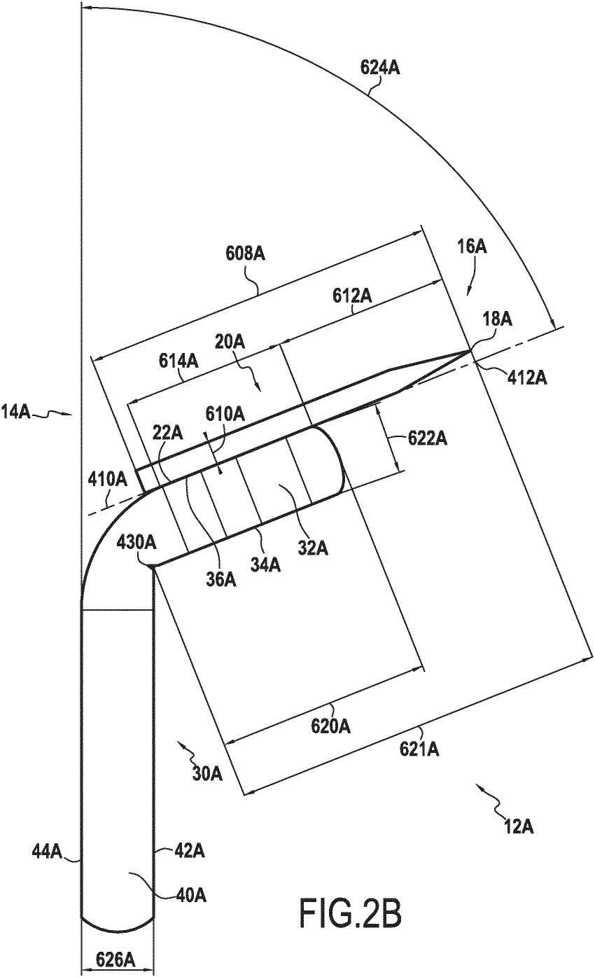

FIG. 2A shows an exemplary blade arrangement 11 for an exemplary shaving head, including at least two directly adjacent and substantially parallel cutting edges 18A, 18B configured to contact skin concurrently during shaving. The exemplary shaving head includes at least two blades 12A, 12B. A first 12A of the at least two blades includes a first 18A of the at least two cutting edges. A second 12B of the at least two blades includes a second of the at least two cutting edges 18B. As with the reference blade arrangement represented in FIG. 1A, in the exemplary blade arrangement 11, the second exemplary blade 12B leads the first exemplary blade 12A when the exemplary shaving head is moved in its shaving direction 600.

The inter-blade clearance 604 between the first 12A and second 12B blades may range from 0.25 mm to 0.55 mm. Additionally or alternatively, the inter-blade span 602 between the first 18A and second 18B cutting edges may range from 0.90 mm to 1.60 mm.

For example, the specific shaving head whose blade arrangement is shown in FIG. 2A may have an inter-blade span 602 of 1.3 mm between the first 18A and second 18B cutting edges, and an inter-blade clearance 604 of 0.42 mm. As such, the exemplary shaving head may be perceived by users as being comparable to the reference shaving head in terms of comfort during shaving, while having greater rinsability than the reference shaving head. However, other combinations of inter-blade clearance and inter-blade span are also contemplated.

Although the blade arrangement 11 is represented as giving the shaving head a blade exposure 606 of 0 µm (microns), it is contemplated for the exposure to be as low as -100 µm (meaning the cutting edges are recessed within the guard by this amount) to as high as 100 µm (meaning the cutting edges protrude from the guard by this amount).

FIG. 2B shows the first blade 12A visible in FIG. 2A.

The first blade 12A includes a cutting element 14A and a support 30A. The cutting element 14A includes the first cutting edge 18A.

The cutting element 14A is mounted on the support 30A, for example by being welded thereto. It is also contemplated, however, for a given cutting element to be mounted on a given support with adhesive, for example. The cutting element 14A may be mounted on a surface of the support that faces towards skin during shaving. It is also contemplated, however, for the cutting element 14A to be mounted on a surface of the support that faces away from skin during shaving.

The cutting element 14A includes a cutting edge portion 16A and a mounting portion 20A. The cutting edge portion 16A includes the first cutting edge 18A.

The mounting portion 20A extends from the cutting edge portion 16A in an opposite direction from the first cutting edge 18A. The mounting portion 20A is mounted on the support 30A.

The cutting element’s mounting portion 20A includes a mounting surface 22A, which is arranged towards the support 30A when the cutting element 14A is mounted thereon.

When the cutting element 14A and the support 30A are mounted to one another, they define an interface surface 410A between them, which is a geometrical reference used to measure certain aspects of blade and/or shaving head geometry. As an example, the interface surface 410A may be coincident with the mounting surface 22A of the mounting portion 20A.

The cutting edge 18A may be formed on the cutting edge portion 16A by any known method. Consequently, the cutting edge 18A may or may not be coincident with the mounting surface 22A of the mounting portion 20A. When the cutting edge 18A of the cutting edge portion 16A is not coincident with the mounting surface 22A of the mounting portion 20A, the interface surface 410A may be understood to extend from the mounting surface 22A in a locally tangential fashion.

As a non-limiting example, the cutting element 14A may have a width ranging from 0.95 mm to 1.68 mm, or even of 1.4 mm for example. The cutting element’s width 608A is the maximum distance to which its mounting portion 20A extends away from its cutting edge 18A, as measured along its mounting surface 22A. When the cutting edge 18A is not coincident with the interface surface 410A, the cutting element’s width 608A may be measured as the maximum distance to which the mounting portion 20A extends away from an orthogonal projection 412A of the cutting edge 18A onto the interface surface 410A.

As a non-limiting example, the cutting element 14A may have a thickness 610A of 0.05-0.15 mm, or even 0.074 to 0.1 mm. The cutting element’s thickness 610A may be measured normal to its mounting surface 22A.

Overhang length is the minimum distance, from a blade’s cutting element’s cutting edge portion’s cutting edge (or an orthogonal projection 412A thereof of onto the interface surface 410A when the cutting edge is not coincident with the mounting surface 22A), to a portion of the mounting surface 22A which is in contact with the support 30A. An overhang length 612A of the first blade 12A may range from 0.5 mm to 1 mm, or 0.55 mm to 1 mm, or even for example from 0.55 mm to 0.88 mm for the first blade 12A. For example, the specific first blade 12A shown in FIG. 2B may have an overhang length 612A of 0.62 mm. Overhang length 612A may contribute to flexibility of the cutting edge portion 14A, which may improve adaptation of the blade 12A to skin contours during shaving.

The support 30A may include a platform portion 32A on which the mounting portion 20A is mounted, and a base portion 40A extending perpendicularly or obliquely away from the platform portion 32A. The support’s platform portion 32A may extend along the cutting element’s mounting portion 20A.

Contact length between the cutting element’s mounting portion 20A and the support’s platform portion 32A may be measured along the cutting element’s mounting portion 20A and perpendicular to the cutting edge portion’s cutting edge 18A. As a non-limiting example, contact length 614A between the mounting 20A and platform portions 32A may range from 0.5- mm to 0.90 mm. For example, the specific first blade 12A shown in FIG. 2B may have a contact length 614A of 0.48-0.72 mm, or even 0.6 mm between its mounting 20A and platform 32A portions.

Platform portion thickness 622A may be measured normal to the mounting portion 20A (for example normal to the interface surface 410A). As an example, the thickness 622A of the platform portion 32A may range from 0.1 mm to 0.3 mm, or even from 0.15 mm to 0.3 mm, , or even from 0.2 mm to 0.3 mm. For example, the specific first blade 12A shown in FIG. 2B may have a support 30A whose platform portion 32A is 0.28 mm thick.

The platform portion 32A includes an inner surface 34A and an outer surface 36A, such that the inner surface 34A of the platform portion 32A is arranged towards the base portion 40A, and the outer surface 36A of the platform portion 32A is arranged away from the base portion 40A. The outer surface 36A may be arranged towards skin during shaving.

The shapes of the platform 32A and mounting 20A portions may conform substantially to one another. For example, when the mounting surface 22A is substantially flat, the platform portion 32A may be substantially flat as well, at least on its outer surface 36A.

The base portion 40A may allow the first blade 12A to be retained in a guard of a shaving head, for example directly adjacent to the second blade 12B visible in FIG. 2A. The base portion 40A includes an inner surface 42A, which is arranged towards the platform portion 32A, and an outer surface 44A, which is arranged away from the platform portion 32A.

Base portion thickness 626A may be measured normal to the inner surface 42A of the base portion 40A. As an example, the base portion 40A may have a thickness ranging from 0.1 mm to 0.3 mm, or even from 0.15 to 0.3 mm, or even from 0.2 mm to 0.3 mm. Additionally or alternatively, as an example, the thickness 626A of the base portion may be similar or identical to that of the thickness 622A of the platform portion. For example, the specific first blade shown in FIG. 2B has a support whose base portion is 0.28 mm thick.

The inner surfaces 34A, 42A of the platform 32A and base portions 40A define an angle between them whose rays lie on the inner surface 34A of the platform portion 32A and the inner surface 42A of the base portion 40A, and whose vertex is known as an “interior vertex” 430A.

Platform portion length 620A may be measured along the mounting portion (for example along the interface surface 410A) and perpendicular to the blade’s cutting element’s cutting edge portion’s cutting edge 18A, from the interior vertex 430A (or an orthogonal projection of the interior vertex onto the mounting 22A or interface 410A surface, when the interior vertex 430A is not coincident therewith), towards the cutting edge 18A (or its orthogonal projection 412A onto the interface surface 410A when the cutting edge 18A is not coincident therewith), to an extremity nearest the cutting edge of an orthogonal projection of the platform portion onto the interface plane.

As an example, the platform portion 32A may have a length 620A ranging from 0.5 mm to 0.9 mm, or even from 0.7 mm to 0.9 mm. For example, the specific first blade 12A shown in FIG. 2B may have a support 30A with a platform portion 32A length 620A of 0.80 mm.

As a non-limiting example, the base portion 40A may extend from the platform portion 32A at a so-called bend angle 624A ranging from 64° (degrees) to 72°, as measured between outer surfaces 44A, 36A of the base 40A and platform 32A portions. The bend angle 624A corresponds to an amount by which a flat element is bent to form the base 40A and platform 32A portions during fabrication of the support 30A.

Blade length 621A may be measured from the interior vertex 430A (or an orthogonal projection thereof onto the interface plane 410A) to the cutting edge 18A (or an orthogonal projection thereof onto the interface plane 410).

Returning now to FIG. 2A, it can be seen that the support 30A may be intermediate the first blade’s cutting element 14A and the second blade 12B, for example such that a line drawn from an extremity of the first blade’s cutting element 14A which is remote from its cutting edge 18A to the second blade 12B may intersect the first blade’s support 30A. The first blade’s cutting element 14A is disposed on a surface of the platform portion 32A which is arranged towards skin during shaving.

It is also contemplated, however, for the first blade’s cutting element 14A to be intermediate the support 30A and the second blade 12B, for example such that a line drawn from the first blade’s mounting surface to the second blade 12A may intersect the first blade’s cutting element 14A. The first blade’s cutting element 14A may be disposed on a surface of the platform portion 32A which is arranged away from skin during shaving.

The height of a blade is the maximum distance between the blade’s support and cutting edge, as measured normal to the shaving surface. As a non-limiting example, the first blade’s height 642A may range from 2.00 mm to 3.0 mm, or even from 2.1 mm to 2.35 mm.

A blade’s “base portion length” is the distance from the support’s interior vertex 430A and an extremity 40A of the base portion 40A remote therefrom. As a non-limiting example, the first blade’s base portion length 628A may range from 0.7 mm to 2.5 mm or even from 1.00 mm to 1.40 mm. For example, the base portion length 628A of the specific first blade 12A shown in FIG. 2A may be 1.38 mm.

The width 644A of the first blade (also known as its so-called “D-dimension”) 12A may be measured in a number of ways. For example, the first blade’s width 644A may be a maximum distance between its cutting edge 18A and an orthogonal projection 414A of the support 30A onto the shaving surface 440, or for example, the first blade’s width 644A may be measured from the base portion’s outer surface 44A to the cutting edge portion’s cutting edge 18A in a direction normal to the base portion’s outer surface 44A. When, as with the specific first blade 12A shown in FIG. 2A, the base portion’s outer surface 44A is arranged perpendicular to the shaving surface 440, the maximum distance between the cutting edge 18A and the orthogonal projection of the support 30A onto the shaving surface 440 may be equivalent to the distance between the base portion’s outer surface 44A and the cutting edge portion’s cutting edge 18A as measured normal to the base portion’s outer surface 44A.

As a non-limiting example, the width 644A of the first blade 12A may range from 0.9 mm to 1.70 mm, or even from 1 mm to 1.55 mm, or even from 1.45 mm to 1.51 mm. For example, the specific first blade shown in FIG. 2A may have a width of 1.5 mm. As a non-limiting example, is also contemplated to provide a first blade 12A whose width 644A is 1.48 mm.

Support width 630A may be measured in a number of ways. For example, it may be a maximum distance between opposite extremities of an orthogonal projection of a blade’s support 30A onto the shaving surface 440, as measured perpendicular to the blade’s cutting edge 18A, or for example, it may be a maximum distance between opposite extremities 39A, 49A of the support’s base 40A and platform 32A portions, as measured normal to the base portion’s outer surface 44A. When, as with the specific first blade shown in FIG. 2A, the base portion’s outer surface 44A is arranged perpendicular to the shaving surface 440, the maximum distance as measured perpendicular to the cutting edge 18A between opposite extremities of the orthogonal projection of the support 30A onto the shaving surface 440 may be equivalent to the maximum distance as measured normal to the base portion’s outer surface 44A between opposite extremities 39A, 49A of the base 40A and platform portions 32A.

As a non-limiting example, the support width 630A of the first blade 12A may range from 0.60 mm to 1.15 mm. For example, the support width 630A of the specific first blade 12A shown in FIG. 2A may be 0.99 mm.

The “edge offset” of a blade is the difference between its blade width and support width, and corresponds substantially to an amount of space available for debris stacking. Debris stacking will be discussed in greater detail with regard to FIGS. 4 & 5. As a non-limiting example, the edge offset 670A of the specific first blade 12A shown in FIG. 2A may be 0.51 mm.

The breadth of the first blade is measured along its cutting edge 18A. As a non-limiting example, the breadth of the first blade 12A may range from 0.95 mm to 1.68 mm.

Although the first 12A and second 12B blades are shown as being identical to one another, it is also contemplated for the second blade 12B to differ from the first blade 12A. When at least a third blade is provided, the first 12A and second 12B blades may each be identical to or different from the third blade, independently of one another.

Overlap length is a difference between the inter-blade span between the cutting edge of a leading blade (for example the second blades 12B & 112B seen in blade arrangements 11 & 111 of FIGS. 1A & 2A) and the cutting edge of a subsequent blade (for example the first blades 12A & 112B seen in blade arrangements 11 & 111 of FIGS. 1A & 2A), which trails the leading blade during shaving, and the width of the leading blade (for example width 644B of the second blade 12B in FIG. 2A).

As a non-limiting example, the overlap length 690 between the first 12A and second 12B blades of an exemplary shaving head may range from 0 mm to 0.55 mm. For example, the specific blade arrangement 11 shown in FIG. 2A may have an overlap length 690 of 0.2 mm.

The shaving head 11 has an edge gap 605, which is a perpendicular distance from a plane 17 containing the cutting edge 18B of the second blade 12B, to the cutting edge 18A of the cutting element 14A of the first blade 12A. The plane 17 is generally parallel to surfaces of the cutting edge portion 16B of the second blade 12B which are arranged towards and away from skin during shaving. As seen in FIG. 2A, the plane 17 may even correspond to a center plane of the cutting edge portion.

The plane 17 and the shaving surface 606 define an angle 625 whose rays extend from the cutting edge 18B of the second blade 12B towards the first blade 12A. The edge gap 605 corresponds to a product of the inter-blade span 602 with the sine of the angle 625 between the plane 17 and the shaving surface 606.

The shaving head 11 has a cutting element gap 607, which is the perpendicular distance between the interface surface 410A of the first blade 12A and a surface of the cutting edge portion 16B of the second blade 12B which is arranged towards skin during shaving. The cutting element gap 607 may be measured as the edge gap 606, minus the sum of the perpendicular distance between the cutting edge 18B of the second blade 12B to the surface of the cutting edge portion 16B of the second blade 12B arranged towards skin during shaving with the perpendicular distance between the cutting edge 18A of the first blade 12A to the interface surface 410A. When these distances are equal, the cutting element gap 607 may be measured as the blade gap 605 minus the thickness of the first blade’s cutting element 14A.

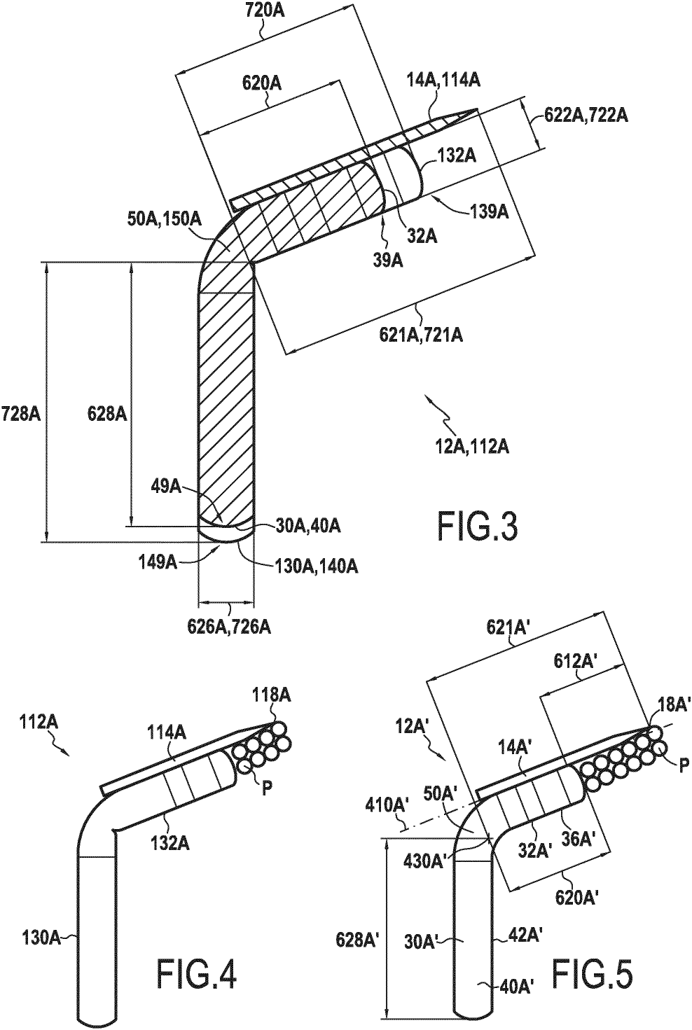

FIG. 3 shows a comparison between the reference first blade 112A seen in FIG. 1A and the exemplary first blade 12A seen in FIG. 2A. For simplicity of comparison, the support 130A of the reference blade 112A is shown as being bent along a bend axis from a flat wire blank with a width (as measured perpendicular to the bend axis and spanning extremities of the blank subsequently corresponding to the extremities 139A, 149A of the base and platform portions of the support 130A) of 2.58 mm, whereas the support 30A of the exemplary blade 12A is shown as being bent along a bend axis from a flat wire blank with a width (as measured perpendicular to the bend axis and spanning extremities of the blank subsequently corresponding to the extremities 39A, 49A of the base and platform portions of the support 30A) of 1.84 mm to 2.76 mm, or even 2.30 mm. For simplicity of comparison, the reference 112A and exemplary 12A first blades are shown as being identical to each other in terms of their cutting elements 14A, 114A, blade lengths 621A, 721A, the thicknesses 726A, 626A, 722A, 622A of their supports’ base 140A, 40A and platform 132A, 32A portions, and the geometries of bent portions 50A, 150A at the junctions of their supports’ base 140A, 40A and platform 132A, 32A portions. Comparison of the reference 112A and exemplary 12A first blades reveals that, despite these similarities, the base portion length 628A for the exemplary first blade 12A is 0.08 mm less than the base portion length 728A for the reference first blade 112A, and the platform portion length 620A for the exemplary first blade 12A is 0.2 mm less than the platform portion length 720A for the reference first blade 112A.

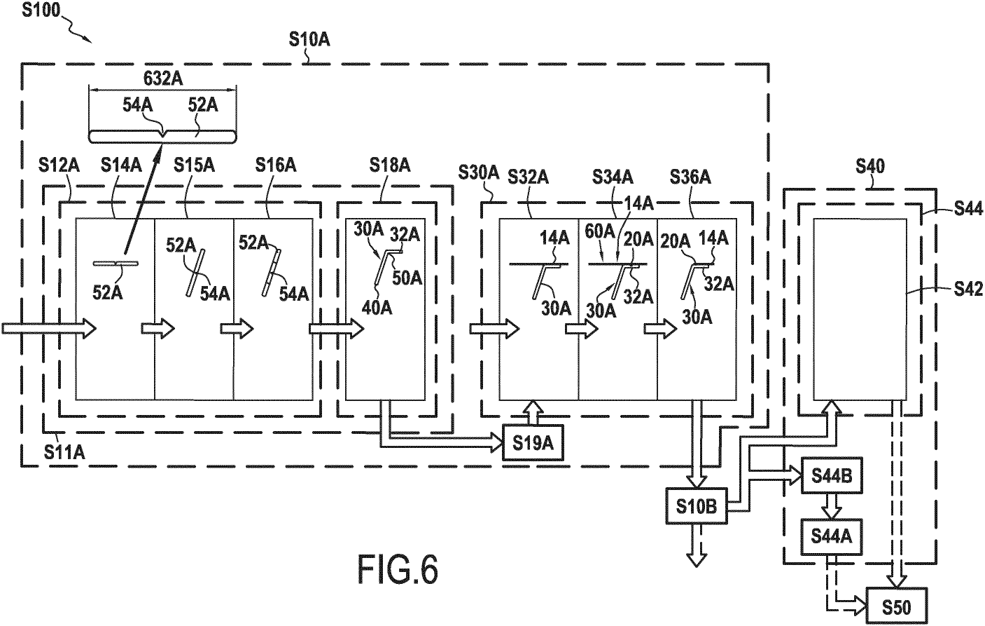

The reduction in base 628A and platform portion 620A lengths - which is not limited to the specific dimensions indicated above - may allow the amount of material contained in the exemplary shaving head to be reduced, with respect to the reference shaving head. This may lead to reduced costs and/or environmental impact during fabrication, for example. Fabrication will be discussed in greater detail with regard to FIG. 6.

The “support ratio” of a blade 12A, 112A is the ratio of its platform portion length 620A, 720A to the length of the blade. When a shaving head includes a leading blade and a subsequent blade, whose edges contact the skin concurrently during shaving such that the subsequent blade’s edge trails the leading blade’s edge during movement of the shaving head in the shaving direction, a trailing blade with a relatively large support ratio may correspond to a smaller inter-blade clearance, for a given inter-blade span and a given leading blade, than a trailing blade with a relatively small support ratio.

As a non-limiting example, the exemplary first blade 12A may have a support ratio ranging from 0.33 to 0.64. For example, the specific exemplary first blade 12A shown in FIG. 3 may have a support ratio of 0.56.

As an example, for two blades 12A, 112A whose cutting elements 14A, 114A are identical but who differ in terms of support ratio, the blade 12A with the smaller support ratio may exhibit a greater capacity for accumulating shaving debris (also called “debris stacking”) than the blade 112A with the larger support ratio.

For example, FIG. 4 shows debris stacking for the reference blade 112A seen in FIG. 3, and FIG. 5 shows debris stacking for an exemplary blade 12A′. The blade 12A′ seen in FIG. 5 differs from the exemplary blade 12A seen in FIG. 3 only in that the blade 12A of FIG. 3 is provided with a groove in its bent portion 50A of its support 30A, whereas the blade 12A′ of FIG. 5 lacks such a groove in the bent portion of its support. Nevertheless, base and platform portion lengths 628A′, 620A′ for the blade 12A′ of FIG. 5 are identical to those of the blade 12A of FIG. 3, and the interior vertex 430A′ of the exemplary blade 12A′ of FIG. 5 is located with respect to the inner surfaces 36A′, 42A′ of the platform 32A′ and base 40A′ portions in the same manner as discussed in FIG. 2B. Notched and un-notched bent portions will be discussed in greater detail with regard to FIG. 6.

Since the exemplary blade 12A′ and the reference blade 112A have identical cutting elements 114A, 14A′ as one another, the above-described differences in the lengths of the base 40A′, 140A and platform 32A′, 132A portions of their respective supports 30A′, 130A mean that the exemplary blade 12A′ shown in FIG. 5 (and also the exemplary blade 12A shown in FIG. 3) has a smaller support ratio than the reference blade 112A shown in FIG. 4.

In both of FIGS. 4 & 5, shaving debris is represented as particles “P” which are substantially circular as viewed along the cutting edge 118A, 18A′ of the blade 112A, 12A′. Comparison of FIGS. 4 & 5 reveals that the exemplary blade 12A′ is able to accumulate more debris particles “P” intermediate its cutting edge 18A′ and platform portion 32A′ than the reference blade 112A is able to accumulate intermediate its cutting edge 118A and platform portion 132A. As such, the exemplary blade 12A′ exhibits better debris stacking than the reference blade 112A. The same is therefore also true for the exemplary blade 12A of FIG. 3.

A blade which exhibits relatively more debris stacking may be able to shave a larger area of skin before needing to be rinsed than a blade which exhibits relatively less debris stacking. As such, a user of a shaving head containing at least one blade with good debris stacking may find that the shaving head needs to be rinsed less often than a comparable shaving head whose blade(s) exhibited poor debris stacking.

A blade with a relatively low support ratio may also exhibit greater flexibility in its cutting edge portion than a blade whose cutting edge portion is identical but which exhibits a relatively high support ratio. Cutting edge portion flexibility may facilitate dislodgement of debris, and/or may exhibit greater vibratory oscillations if used in conjunction with a vibrator. This possibility will be discussed in greater detail with regard to FIG. 11.

FIG. 6 shows a process flow diagram for an exemplary method of fabrication S100 of an exemplary shaving head. The method S100 includes providing the first blade S10A, providing the second blade S10B, and assembling the first and second blades together S40.

Providing the first blade S10A may include providing its support S11A, providing its cutting element S19A, and assembling the support and cutting element together S30A to obtain a blade.

Providing the support S11A may include providing a flat element S12A and bending the flat element S18A to obtain the support. As a non-limiting example, the flat element 52A may have a width 632A of 2.30 mm, as measured perpendicular to an axis along which bending S18A occurs, between portions of the flat element subsequently corresponding to extremities of the base and platform portions of the support.

Providing the flat element S12A may include providing a wire of raw material (for example of a diameter from 4 mm to 6.5 mm, or even 5 mm) which is flattened by a drawing (i.e. rolling (hot rolling or cold rolling) and/or polishing and/or cutting and/or annealing process (that improves ductility)) to yield a flat element 52A. The flat or flattened wire may be made of stainless steel, for example austenitic stainless steel, and/or may have a width from 2 mm to 3 mm, or even from 2.2 mm to 2.4 mm. The two ends of the flat element may be rounded.

Bending the flat element S18A forms the support’s base 40A and platform 32A portions, as well as a bent portion 50A by which the base 40A and platform 32A portions are connected to one another, such that the base 40A and platform 32A portions are perpendicular or oblique to one another, at least at their respective junctions with the bent portion 50A. It is contemplated that the bent portion 50A may include a groove 54A, which may allow for a relatively small or no radius of bending in the bent portion 50A, or that the bent portion 50A may be un-grooved, which allows bending to be performed without a groove forming step. The groove 54A may be located, for example, between surface portions of the flat element which subsequently correspond to inner surfaces of the base 40A and platform 32A portions of the support.

When a groove 54A is to be provided, the flat element 52A may undergo groove formation S14A prior to bending S18A. For example, groove formation S14A may create one or more grooves 54A in the flat element 52A, which may locally increase the flat element’s susceptibility to bending S18A. The groove formation S14A may be performed by means of a roller, for example as described in U.S. Pat. n° 9,289,909, and/or by means of material removal, for example. As a result, a support 30A obtained from a flat element 52A that had undergone groove formation S14A may have a bent portion 50A that is smaller and/or whose bent portion’s bend radius is smaller than a support obtained from a flat element of the same size which had not undergone groove formation. Providing the flat element S12A may additionally include straightening the flat element S15A after the groove 54A is formed.

Additionally or alternatively, the flat element may undergo notching S16A prior to bending. Notching may facilitate cutting the flat element to length, for example. Notching may be performed for example as described in U.S. Pat. n° 9,289,909, for example.

Bending the flat element S18A transforms the flat element into a bent element. Subsequent to bending, the bent element may be cut to length to yield the support. Assembling the cutting element and the support together S30A may include mounting S34A the cutting element 14A on the support 30A. As a non-limiting example, mounting the cutting element on the support S34A may be performed by welding the cutting element’s mounting portion 20A to the support’s platform portion 32A.

Prior to mounting the element on the support S34A, the cutting element 14A and support 30A may undergo positioning S32A to situate the mounting portion 20A on the platform portion 32A.

The cutting element 14A may be provided as a section of material 60A, and may undergo cropping S36A, to remove the cutting element 14A from its surroundings. Cropping S36A may be performed subsequent to mounting S34A, for example.

Providing the first blade S10A may lack a step of removing material from the platform portion 32A of the support 30A subsequent to bending S18A. Providing the first blade S10A may additionally lack a step of removing material from the base portion 40A of the support 30A subsequent to bending S18A, or may even lack a step of removing material from the support 30A subsequent to bending S18A. Avoiding material removal may reduce raw material use during fabrication, and possibly also waste generation during fabrication.

As a non-limiting example, providing the second blade S10B may be performed in an identical manner to providing the first blade S10A.

Assembling the first and second blades together S40 may be performed by providing the guard and retaining both of the first 12A and second 12B blades to the guard. As a non-limiting example, the first 12A and second 12B blades may undergo stacking S42 to provide a stack of blades, which are then retained to the guard substantially simultaneously S44. Alternatively, two directly adjacent blades may be retained in sequence. For example, the first blade 12A may be retained S44A to the guard after the second blade has been retained S44B to the guard.

It is also contemplated to measure the rinsability of the shaving head S50. As a non-limiting example, measuring rinsability S50 may be performed during fabrication S100.

FIG. 7A shows a process flow diagram for an exemplary process for measuring rinsability S50 of a shaving head.

Measuring a shaving head’s rinsability S50 includes mounting the shaving head S52 downstream of a liquid dispenser and upstream of a first flow path and a second flow path that is separate from the first flow path, such that liquid dispensed from the liquid dispenser is delivered to the shaving head, and such that liquid traversing the shaving head is directed along the first flow path, and such that liquid bypassing the shaving head is directed along the second flow path. In this way, liquid which has traversed the shaving head may be kept separate from liquid which has bypassed the shaving head. Since liquid which traverses the shaving head is considered to contribute more significantly than liquid which bypasses the shaving head to dislodging debris which may accumulate in the shaving head, separation of the two makes it possible to quantify proportion of liquid used during rinsing which is susceptible to produce the debris dislodgement effect.

The process S50 includes dispensing a liquid S56 from the liquid dispenser, and measuring a quantity of liquid S60 directed along the first flow path and/or a quantity of liquid directed along the second flow path. Thus, it is possible to determine how much of the dispensed liquid would and/or would not contribute to dislodging debris.

As a non-limiting example, the process S50 may include collecting liquid directed along the first flow path S58A and/or collecting liquid directed along the second flow path S58B. Collecting the liquid directed along a given flow path may allow for the quantity of the liquid to be measured after dispensing has ceased.

The process S50 may include arranging a gasket S54 between the shaving head and a boundary of the first flow path. Arranging the gasket S54 may be performed prior to dispensing the liquid S56. The gasket may help to prevent leaking from occurring between the shaving head and the boundary of the first flow path.

The liquid may be dispensed from the liquid dispenser in a known quantity. Providing a known quantity of liquid may allow for different rinsing techniques to be examined and compared. As a result, it may be possible to determine whether a user of a given shaving head can obtain improved rinsing through use of a particular rinsing technique.

The known quantity may be dispensed according to predetermined flow profile, which may be constant or time-dependent. A predetermined flow profile may serve as a standardized representation of rinsing behavior. A standardized representation of rinsing behavior may allow direct comparison of shaving heads’ rinsabilites.

FIG. 7B shows a schematic view of an apparatus 80 for measuring rinsability of a shaving head 9. The apparatus 80 includes a liquid dispenser 81, a first flow path 84A, and a second flow path 84B which is separated from the first flow path 84A.

The liquid dispenser 81 may be provided as a reservoir of known geometry. For example, the reservoir may be substantially cylindrical in shape, with its axis oriented substantially vertically and with a known diameter. A dispensation orifice 82, from which liquid 88 dispensed by the liquid dispenser 81 is directed towards the shaving head 9, may be provided at a lower axial surface 83 of the reservoir. The reservoir may be configured to dispense a known quantity of liquid, for example two liters of water. Other quantities and/or liquids are also contemplated.

Alternatively, the liquid dispenser 81 may be configured to provide a constant flow of water, for example the liquid dispenser 81 may be configured to dispense 92 ml (milliliters) per second of water (or other liquid) for a period of five seconds. Other flow rates and/or durations are also contemplated.

An entry 85A to the first flow path 84A may be arranged to be coaxial with a dispensation path along which liquid 88 from the liquid dispenser 81 exits the dispensation orifice 82. An entry 85B to the second flow path 84B may be arranged to surround (or even be coaxial with) the entry 85A to the first flow path 84A.

A support 89 is located at the entry 85A to the first flow path 84A. The support 89 is configured to hold a shaving head 9, such that the shaving head 9 is situated between the dispensation orifice 82 and the entries 85A, 85B to the first 84A and second 84B flow paths.

The support 89 includes an opening 90 and a flange 91. The flange 91 extends from the opening 90 to the boundaries 86A of the first flow path 84A. Liquid 88 dispensed by the liquid dispenser 81 may enter the first flow path 84A by passing through the opening 90, and may enter the second flow path 84B by bypassing the support 89. The flange 91 may even be sealed to the boundaries 86A of the first flow path 84A.

The support 89 is configured to hold the shaving head 9 such that the blades of the shaving head 9 are arranged between the opening 90 and the dispensation orifice 82. As such, liquid 88A which traverses the blades of the shaving head 9 is generally able to pass into the first flow path 84A via the opening 90.

The dispensation orifice 82 may be oriented such that the dispensation path is oriented vertically downward. Entries 85A, 85B to the first 84A and second 84B flow paths may be situated vertically below the dispensation orifice 82. For example, when a shaving head 9 is mounted to the support 89, the dispensation orifice 82 may be arranged approximately 15 cm (centimeters) vertically above the shaving head 9. Other distances are also contemplated.

The first flow path 84A terminates in a volumetric vessel 87A, which serves to collect and measure the quantity of liquid 88A directed along the first flow path 84A. This measurement may serve as an indication of the amount of dispensed liquid 88 which could contribute to dislodging debris from the shaving head 9. For example, the volumetric vessel 87A may be entire the first flow path 84A.

When measurement of the quantities of liquid 88A, 88B directed along both first 84A and second 84B flow paths is desired, the second flow path 84B may terminate in a second volumetric vessel 87B. It is contemplated that the volumetric vessel 87A in which the first flow path 84A terminates could be arranged within the volumetric vessel 87B in which the second flow path 84B terminates.

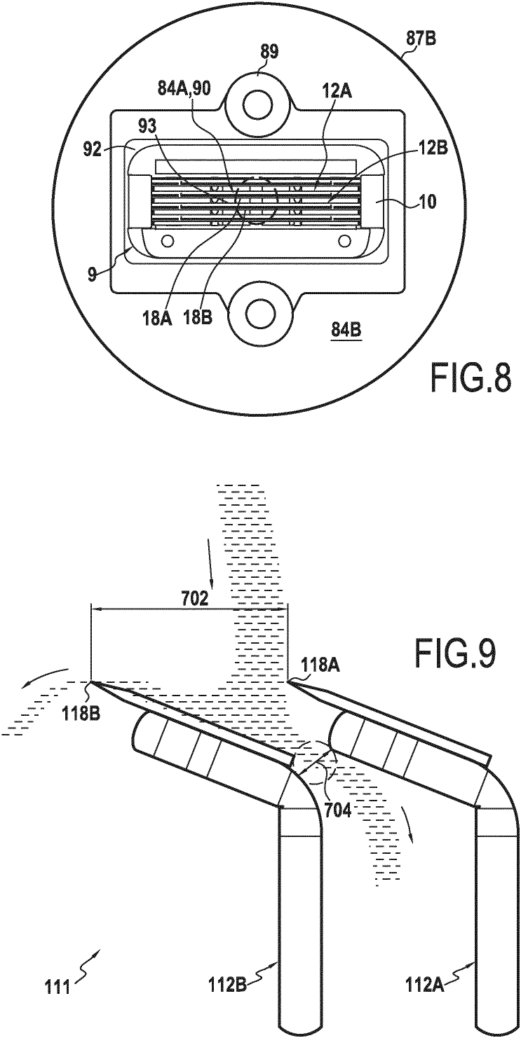

FIG. 8 shows a detail view of the apparatus represented in FIG. 7B, as seen looking along the dispensation path towards the support 89. A gasket 92 is arranged between the support 89 and the guard 10 of the shaving head 9, such that the opening 90 is sealed, except as regards space between the blades 12A, 12B of the shaving head 9. As such, liquid which bypasses the shaving head 9 (instead of traversing the shaving head 9) may be prevented from entering the first flow path 84A and may instead be directed along the second flow path 84B, for example into the second volumetric vessel 87B.

Liquid may be dispensed from the liquid dispenser and delivered to only a portion of the shaving head 9. For example, the dispensed liquid may be provided as a stream which is substantially circular in cross-section (as seen perpendicular to the dispensation path) with a diameter of approximately ranging from 5 cm (centimeter) to 2 cm. Such a stream may be representative of water flow from a typical bathroom faucet. Aeration of the dispensed liquid is also contemplated. For example, the dispensed liquid may be delivered to an impact area 93 which is substantially circular in shape as viewed along the dispensation path. The impact area 93 may be located at a midpoint between midpoints of directly adjacent cutting edges 18A, 18B of the shaving head 9, for example.

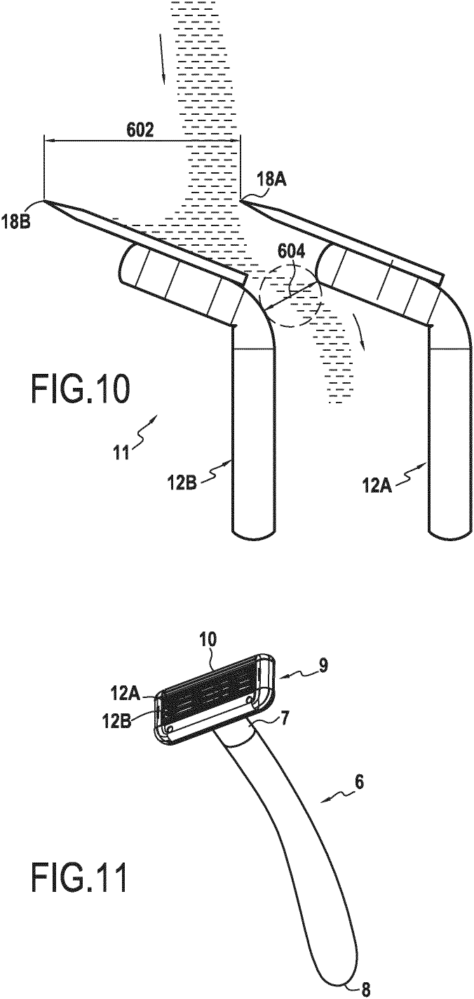

FIG. 9 shows a schematic representation of the reference blade arrangement 111 of FIG. 1A during rinsing, and FIG. 10 shows a schematic representation of the blade arrangement 11 of FIG. 2A during rinsing. For simplicity of comparison, the shaving heads whose blade arrangements 111, 11 are shown in FIGS. 9-10 have identical guards to one another, and 460 ml of water was dispensed to each of these shaving heads at a rate of 92 ml/s (milliliters per second) for 5 seconds, with identical flow geometry, and each shaving head was tested five times. Comparison of FIGS. 9-10 reveals that, although the two shaving heads were comparable in terms of their ability to admit water between the cutting edges 118A, 18A, 118B, 18B of their respective first 112A, 12A and second 112B, 12B blades, owing to their identical inter-blade spans 702, 602 (1.3 mm), significantly less water was able to traverse the reference shaving head whose blade arrangement 111 is shown in FIG. 9 than the exemplary shaving head whose blade arrangement 11 is shown in FIG. 10, owing to the difference in the two shaving heads’ inter-blade clearance 704, 604.

On average, 149 ml was observed to traverse the reference shaving head, which has an inter-blade clearance 704 of 0.29 mm, whereas 212 ml was observed to traverse the exemplary shaving head, which has an inter-blade clearance 604 of 0.42 mm. As a result, tests support the understanding that increased inter-blade clearance corresponds to increased rinsability.

FIG. 11 shows an exemplary razor 6 including an exemplary shaving head 9. As a non-limiting example, the exemplary razor’s exemplary shaving head 9 may be the shaving head whose blade arrangement was presented in FIG. 2A, for example. The first 12A and second 12B blades are retained within a guard 10 of the shaving head 9.

The razor’s shaving head 9 is attached to a manipulation portion 8 of the razor 6 - in this case a handle. The shaving head 9 and manipulation portion 8 may be removably attached to each other or permanently attached to each other.

The razor 6 may include one or more vibrators 7. As a non-limiting example, the one or more vibrators 7 may be provided in the shaving head 9 and/or in the manipulation portion 8. The one or more vibrators 7 may allow vibrations to be transmitted to the skin by way of the shaving head 9, for example by way of the blades 12A, 12B of the shaving head 9.

Although the described embodiments were provided as different exemplary embodiments, it is envisioned that these embodiments are combinable or, when not conflicting, the features recited in the described embodiments may be interchangeable. Moreover, the features recited in the described embodiments are not inextricably linked to one another, unless such a linkage is clearly indicated between two given features.

Throughout the description, including the claims, the term “comprising a” should be understood as being synonymous with “comprising at least one” unless otherwise stated. In addition, any range set forth herein, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

1-15. (canceled)

16. A shaving head comprising a guard, a first blade, and a second blade, the first blade comprising a first cutting element and a support, the first cutting element comprising a cutting edge portion and a mounting portion, the cutting edge portion presenting a cutting edge, the mounting portion extending from the cutting edge portion in an opposite direction from the cutting edge, the mounting portion being mounted on the support, the second blade comprising a second cutting element presenting a cutting edge, the first and second blades being arranged directly adjacent to one another such that the cutting edges of the first and second cutting elements are substantially parallel to each other and arranged to contact skin concurrently during shaving, and such that an inter-blade clearance, which is a minimum distance between directly adjacent blades, between the fir to 0.55 mm, and such that an inter-blade span, which is a distance between two directly adjacent cutting edges, between the first and second cutting elements ranges from 0.90 mm to 1.60 mm.

17. The shaving head of claim 16, wherein an overhang length of the first blade ranges from 0.5 mm to 1 mm, the overhang length being the minimum distance, from a blade’s cutting element’s cutting edge portion’s cutting edge or an orthogonal projection thereof of onto the interface surface when the cutting edge is not coincident with the mounting surface, to a portion of the mounting surface which is in contact with the support.

18. The shaving head of claim 16, wherein an overhang length of the first blade ranges from 0.55 mm to 1 mm, the overhang length being the minimum distance, from a blade’s cutting element’s cutting edge portion’s cutting edge or an orthogonal projection thereof of onto the interface surface when the cutting edge is not coincident with the mounting surface, to a portion of the mounting surface which is in contact with the support.

19. The shaving head of claim 16, wherein an overhang length of the first blade ranges from 0.55 mm to 0.88 mm, the overhang length being the minimum distance, from a blade’s cutting element’s cutting edge portion’s cutting edge or an orthogonal projection thereof of onto the interface surface when the cutting edge is not coincident with the mounting surface, to a portion of the mounting surface which is in contact with the support.

20. The shaving head of claim 16, wherein the support includes a platform portion on which the mounting portion is mounted such that the platform portion extends along the mounting portion, and a base portion extending obliquely or perpendicularly from the platform portion for retention of the first blade to the guard, the base portion has a thickness of 0.1 mm to 0.3 mm, as measured normal to an inner surface of the base portion.

21. The shaving head of claim 16, wherein the support includes a platform portion on which the mounting portion is mounted such that the platform portion extends along the mounting portion, and a base portion extending obliquely or perpendicularly from the platform portion for assembly of the first blade to the guard, the platform portion has a length of 0.5 mm to 0.9 mm, the platform portion’s length is measured along the mounting portion and perpendicular to the cutting edge portion’s cutting edge, from an interior vertex formed by surfaces of the platform and base portions which face one another, towards the cutting edge of the cutting edge portion.

22. The shaving head of claim 16, wherein the support includes a platform portion on which the mounting portion is mounted such that the platform portion extends along the mounting portion, and a base portion extending obliquely or perpendicularly from the platform portion for assembly of the first blade to the second blade, a ratio of a length of the platform portion to a length of the first blade ranges from 0.33 to 0.64, the platform portion’s length is measured along the mounting portion, from an interior vertex formed by surfaces of the platform and base portions which face one another, towards the cutting edge of the cutting edge portion, and the blade’s length is measured along the mounting portion, from the interior vertex to the cutting edge.

23. The shaving head of claim 16, wherein the support includes a platform portion on which the mounting portion is mounted such that the platform portion extends along the mounting portion, and a base portion extending obliquely or perpendicularly from the platform portion for assembly of the first blade to the second blade, an outer surface of the base portion is arranged away from the platform portion, a width of the first blade ranges from 0.9 mm to 1.70 mm, the first blade’s width is measured from the outer surface of the base portion to the cutting edge of the cutting edge portion in a direction normal to the outer surface of the base portion.

24. The shaving head of claim 23, wherein an overlap length between the first and second blades ranges from 0 mm to 0.55 mm.

25. The shaving head of claim 16, wherein the first and second blades are arranged directly adjacent to one another such that the support is intermediate the first cutting element and the second blade, or such that the first cutting element (14A) is intermediate the support (30A) and the second blade (12B).

26. The shaving head of claim 25, wherein the first cutting element is arranged on a surface of the support which is arranged towards skin during shaving.

27. The shaving head of claim 25, wherein the first cutting element is arranged on a surface of the support which is arranged away from skin during shaving.

28. A razor comprising a shaving head according to claim 16.

29. The razor of claim 28, comprising a vibrator.

30. A method of fabricating a shaving head according to claim 16, comprising providing the first blade and providing the second blade, and assembling the first and second blades together.

31. The method of claim 30, wherein providing the first blade includes providing the first cutting element and providing the support, and providing the support comprises providing a flat element and bending the flat element to obtain the support, the support including a base portion for assembly of the first blade to the second blade and a platform portion to which the first cutting element is mountable, extending obliquely or perpendicularly from the base portion, and wherein providing the first blade lacks a step of removing material from the platform portion of the support subsequent to the bending step and optionally further comprising a step of measuring rinsability of the shaving head.
